(19) United States
(12) Patent Application Publication
(10) Pub. No.: US 2017/0233839 A1
(43) Pub. Date: Aug. 17, 2017

(54) BLAST FURNACE PLANT

(71) Applicant: Paul Wurth S.A., Luxembourg (LU)

(72) Inventor: Lionel HAUSEMER, Sandweiler (LU)

(21) Appl. No.: 15/504,624

(22) PCT Filed: Aug. 18, 2015
(86) PCT No.: PCT/EP2015/068969

§ 371 Date: Feb. 16, 2017

(30) Foreign Application Priority Data
Aug. 19, 2014 (LU) LU 92 525

(51) Int. Cl. C21B 7/00; C21B 7/10; F27D 17/00

(52) U.S. Cl. CPC C21B 7/002; F27D 17/002; F27D 17/008; C21B 7/10; C21B 2100/44

(57) ABSTRACT

The invention relates to a blast furnace plant (1, 1a-1c) with a blast furnace (2) and a charging device (3) for the blast furnace (2). In order to provide an economical way of providing clean gas to the charging device, the invention provides that the blast furnace plant (1, 1a-1c) further comprises: at least one nozzle (6) for introducing a clean gas into said charging device (3); a cleaning device (7) which is connected for receiving gas from the blast furnace (2) and arranged for removing dust from the gas; at least one compressor (9) arranged for receiving gas from the cleaning device (7), compressing the gas and feeding the gas to the at least one nozzle (6); and at least one turbine (8) connected for receiving and being driven by gas from the blast furnace (2), the at least one turbine being mechanically coupled to drive the at least one compressor (9).

### TECHNICAL FIELD

The invention relates to a blast furnace plant, to a gas recirculation arrangement for a blast furnace plant and to a method for operating a blast furnace plant.

### BACKGROUND ART

As it is well known in the art, the charging of a blast furnace is conventionally carried out by means of a top charging installation, which serves the function of storing raw materials on the furnace top and distributing these materials into the furnace. Raw materials are weighed in the stockhouse and delivered in a batch mode (via skip car or conveyor belt) to the furnace top charging installation, where they are stored in intermediate hoppers.

For distributing the charge material (burden) into the furnace, the top charging installation comprises a rotary charging device arranged on the furnace throat and below the material hoppers. The rotary charging device comprises a stationary housing and a suspension rotor with a charge distributor, the suspension rotor being supported in the stationary housing so that it can rotate around the furnace axis. The suspension rotor and stationary housing form the main casing of the rotary charging device, in which mechanisms for driving the suspension rotor and pivoting the charge distributor are arranged.

As it is also known in the art, whilst the stationary housing and suspension rotor cooperate to form a closed casing, the rotary mounting of the suspension rotor and the operational play between the moving (suspension rotor) and stationary (housing) parts requires an annular gap. In use, furnace gases may enter the main casing through this annular gap.

In order to prevent the entrance of furnace gas, heavily loaded with dust, into the main casing of the rotary charging device, it is known to fill the casing with nitrogen. For an efficient result, the nitrogen flow should be high enough to maintain the pressure level in the main casing above the pressure in the furnace interior. Usually, a flow rate ranging from 100 to 1000 Nm³/h is injected to create a slight overpressure e.g. up to 0.1 bar (compared to the blast furnace top pressure) in the main casing. However, consumption of nitrogen may be high and lead to increased operation costs.

In order to avoid the use of nitrogen, it is also known in the art to recirculate top gas from the blast furnace by at least partially removing the dust particles and afterwards compressing it before it is injected into the main casing. However, compressors used to achieve the necessary overpressure at the aforementioned respective flow rates have a high power consumption, ranging 3 to more 30 kW. As a result, acquisition and operation expenses are very high. Additionally, maintenance of such compressors is cost intensive.

LU 73 752 discloses such process for the treatment of particle laden blast furnace gas, wherein a portion of the exhaust gas is withdrawn from the main flow path at a point upstream of the final washing. The withdrawn portion is further cleaned and pressurized by a compressor bloc of low power in order to be injected into the furnace control chamber and storage hoppers.

WO 2010124980 discloses a method for feeding burden to a blast furnace, wherein a portion of the blast furnace top gas is subjected to a carbon dioxide removing recycling process. The portion of top gas is further passed through a booster unit and buffer tank to be compressed and is fed as pressurizing gas to the hopper chambers of the blast furnace.

### BRIEF SUMMARY

Herein provided is an economical and environmentally friendly way of supplying clean gas to a charging device.

The invention relates to a blast furnace (BF) plant with a blast furnace and a charging device for the blast furnace. The charging device is arranged for charging raw materials (i.e. charge materials) into the blast furnace. Optionally, it may also be adapted to temporarily store such raw materials. Normally, the charging device is arranged on top of the blast furnace and is of a bell less top (BLT) charging type.

The inventive blast furnace plant further comprises at least one nozzle for introducing a clean gas into said charging device. This means that the gas is introduced into some portion of the charging device, which is at least more or less surrounded by a housing or the like and may therefore at least temporarily contain the gas. The term “clean gas” is to be understood as a gas that contains significantly less solid particles than the top gas of the furnace. This includes a gas having a residual dust content, which may otherwise be referred to as “semi-clean”. The term “nozzle” is to be understood in the broadest sense and may also refer to a very simple embodiments where the nozzle is just an open end of the tube. Of course, more complex nozzles can be employed in order to adjust characteristics like flow rate, speed, pressure etc. of the gas.

The BF plant also comprises a cleaning device, which is connected for receiving gas from the blast furnace, namely so-called BF top gas (i.e. gas from the BF throat), and arranged for removing dust from this top gas. Of course, the connection may be achieved by conventional piping known in the art. Also, the cleaning device may employ one or several types of dust collectors, like inertial separators, fabric filters, wet scrubbers and/or electrostatic precipitators. The cleaning device is configured to remove the dust at least partially, and preferably removes the largest part of the dust. In particular, it may be configured to remove the dust down to a residual content of less than 20 mg/m³, preferably less than 10 mg/m³.

At least one compressor is arranged for receiving gas (preferably clean or at least partially cleaned, e.g. semi-cleaned) from the cleaning device, compressing the gas and feeding the gas to the at least one nozzle. Again, the compressor can be connected to the cleaning device as well as to the at least one nozzle by conventional piping. The compressor may in principle be of any type known in the art. The term “compressor” is to be understood in the broadest sense as a device that is adapted to compress a gas. In particular, a centrifugal compressor or a water-ring compressor can be used. It may also be a two-stage or multi-stage compressor. The compressor is used to increase the pressure of the previously cleaned gas before providing it to the nozzle(s), so that the pressure of the cleaned gas introduced into the charging device exceeds the pressure of the top gas of the blast furnace below.

The BF plant furthermore comprises at least one turbine, which is connected for receiving and being driven by gas from the blast furnace, namely BF top gas. Again, the connection to the blast furnace can be achieved by conventional piping. It should be noted that the turbine is usually not connected directly to the blast furnace, but a cleaning device, in particular the cleaning device used for the compressor, is connected between the blast furnace and the turbine. Typically, the at least one turbine is connected for receiving and being driven by gas from the cleaning device, which in turn receives BF top gas.

The turbine can in principle be any type known in the art. The turbine receives gas from the blast furnace and is driven by the expansion of the gas. According to the invention, the at least one turbine is mechanically coupled to drive the at least one compressor. This means that the enthalpy of the turbine, which is created by the expansion of gas from the blast furnace, is transferred to the compressor, where it is used to compress the cleaned gas, which is afterwards injected into the charging device. In other words, the expansion of one gas volume drives the compression of another gas volume. The turbine is mechanically coupled to the compressor, which means that there is no intermediate conversion of the energy e.g. into electrical energy. Therefore, inevitable losses inherent in such conversion can be prevented.

Most importantly, the present invention does not need any external supply of clean gas and no additional energy supply to drive the compressor. The clean gas that is used is top gas taken from the blast furnace, which can be considered as “cheap”. Also, the energy used in the compressor is gained from the energy of the turbine, which in turn results from the pressure of the gas from the blast furnace. In effect, the compression is driven by thermal energy from the blast furnace, the amount of which however is negligible compared to the total thermal energy of the blast furnace. Therefore, the inventive concept is highly economical. Also, the energy for the compressor is created locally and does not have to be transferred over longer distances, like in an electrically driven compressor.

So, in practice, the present invention relies on the use of a turbocharger-like device in order to compress cleaned top gas for use in the BF charging device, the turbocharger being fed both on the compressor and turbine side with cleaned top gas (although possibly at different cleaning and pressure levels). As will be explained below, the so-compressed cleaned top gas can be used at several locations in the charging device, e.g. in the main casing, in the hoppers and in the valve actuation unit.

It should be noted that the expanded gas exiting the turbine normally has a high content of combustible components and therefore may be used to supply a burner, for instance to create steam which drives another turbine for creating electrical energy or the like, or be fed back to the plant gas network.

The charging device may generally comprise a main casing with a stationary housing and a suspension rotor for a movable distribution chute, said suspension rotor being rotatably mounted with respect to the housing, wherein at least one nozzle is disposed to introduce clean gas into the main casing. The main casing is part of a distribution installation. Normally, it has a central vertical channel through which raw materials are gravity-fed to the distribution chute at the lower end of the channel. The chute is normally tiltable and it is rotatable by rotating the suspension rotor on which it is mounted. The main casing typically houses the gear components for turning the rotor and tilting the chute. The at least one nozzle may be disposed simply to create an overpressure within the main casing. Additionally or alternatively, at least one nozzle arrangement may be arranged to create a curtain-like gas flow, which flows across a gap between the stationary housing and the suspension rotor, hereby blocking the gap. The latter option is described e.g. in WO 2013/013972 A2.

Also classically, the charging device comprises at least one hopper for raw materials to be fed into the blast furnace, wherein at least one nozzle is disposed for introducing gas into said hopper. The hopper is used to store the raw materials before distributing them in the blast furnace e.g. by means of a distribution chute as described above. In such a case, the hopper is normally located above the main casing. Often, a plurality of hoppers is employed. It is understood that the hopper does not have to be disposed vertically above the main casing, but may e.g. be laterally offset. It is known in the art to introduce nitrogen gas or semi-cleaned BF gas into such a hopper for primary and secondary pressure equalization. However, it is possible to use the clean, compressed gas from the compressor for this purpose, too. This may be done alternatively or additionally to the introduction of gas into the main casing. Besides saving costs for nitrogen, this has another positive effect. Since the gas inside the hopper has no extra nitrogen added, its calorific value is not altered (not reduced by the presence of N₂). It may be noted that while the introduction of compressed cleaned gas in the main casing is generally continuous, the use of the compressed cleaned gas in the hoppers is a sequential process, since the gas is mainly needed when the hoppers are emptied. The required volume may be substantial and it is of advantage to store compressed cleaned gas in an intermediate buffer in the line between the compressor and the hoppers.

Compressed clean gas can also be used in the so-called “valve actuation unit” located below the hoppers and comprising material dosing valves and sealing valves at the hopper outlets.

A top gas cleaning device is a conventional component of a BF plant. Typically, considering the amount of top gas exiting the BF, only a part thereof will be used in the charging device. Accordingly, the gas cleaning in the context of the present invention can be carried out with the conventional gas cleaning device of the BF furnace. Preferably, the cleaning device comprises a first cleaning stage and a second cleaning stage for sequentially cleaning the gas. In particular, the first cleaning stage may be a dry cleaning stage and the second cleaning stage may be a wet cleaning stage. These may also be referred to as dry separator and wet separator, respectively. Such a design for the cleaning device is, in principle, known in the art and leads to a very effective dust removal. However, the present invention may also employ the two-stage design to selectively access gas of different degrees of purity, i.e. gas which has been cleaned to different degrees. This will be explained below.

Depending on the embodiments, and on the presence of a TRT turbine (Top Gas Recovery Turbine), cleaned gas at different purity levels (and hence pressures) can be used in the compressor and in the turbine. For example, the compressor and/or the turbine can be fed with clean gas, i.e. gas from the second cleaning stage, or with partially cleaned gas from the first cleaning stage or from another intermediate location in the cleaning device. In practice, when the BF plant comprises a TRT, both the compressor and turbine can be fed with clean gas. In the absence of TRT, the turbine is preferably fed with semi-clean gas while the compressor is fed with clean gas.

According to one embodiment, the turbine is connected to receive gas from an intermediate cleaning stage of the cleaning device (e.g. after the first stage of the scrubber). That is, a piping which connects the turbine to the cleaning device bypasses the second cleaning stage. This influences the gas supplied to the turbine in two ways: on the one hand, there is a residual amount of dust in the gas, which would otherwise be removed by the second cleaning stage. I.e. the gas can be considered as semi-clean. On the other hand, the enthalpy of the gas is usually higher due to a higher temperature (e.g. by 100 to 200° C.) and higher pressure, in particular if the first cleaning stage is a dry separator (like a cyclone) and the second cleaning stage is a wet separator. Since the mechanical work available for driving the turbine is a linear function of the temperature, the effectiveness of the turbine is highly enhanced.

In the above-mentioned embodiment, the residual dust in the gas could have a detrimental effect on the turbine, e.g. by settling on the surfaces and between moving parts or by causing abrasion. To prevent this, an intermediate cleaning device may be disposed between the first cleaning stage and the turbine.

In an alternative embodiment, the turbine is connected to receive gas from the second cleaning stage. This gas can be considered as fully cleaned (i.e. virtually dust-free) and will preserve a long lifetime of the turbine. This also has the advantage that one and the same cleaning device (with its first and second cleaning stage) can be used for the gas supply of the turbine and the compressor.

As has been explained above, the second cleaning stage, which usually is a wet cleaning stage, may significantly reduce the enthalpy of the gas by reducing its temperature. It is conceivable to re-heat the gas after passing through the second cleaning stage. One option to do this is to employ a heat exchanger through which the gas is passed. The blast furnace produces large amounts of excess heat, which may be used in this context. Therefore, according to one embodiment, a heat exchanger is arranged between the second cleaning stage and the turbine, which heat exchanger is arranged to use heat from the blast furnace. During operation, gas flows from the second cleaning stage to the heat exchanger and from there to the turbine. The heat exchanger heats up the gas and enhances its enthalpy. The heat source of the heat exchanger is the blast furnace. The heat exchanger therefore may be located adjacent or on the blast furnace itself or a piping may be supplied to guide hot top gas from the furnace to the heat exchanger.

While the temperature of the gas supply to the turbine has a great impact on the efficiency of the turbine, this is of minor importance with respect to the compressor. Even cooler gas can be effectively used in the compressor. Therefore, it is preferred that the compressor is connected to receive gas from the second cleaning stage. This gas can be considered as dust-free, which enhances the lifetime of the compressor and reduces the need for maintenance. In this connection, it will be understood that a cool compressed clean gas is of advantage for cooling purposes in the main casing. Also, a certain amount of moisture may be desirable to enhance the cooling effect of the compressed gas.

There are numerous possibilities to mechanically couple the at least one turbine and the at least one compressor. For instance, a gear may be supplied for connecting several compressors to one turbine or one turbine to several compressors. According to a preferred embodiment, at least one turbine and at least one compressor are connected by a common shaft for concerted rotation, i.e. when one rotation of the turbine corresponds to one rotation of the compressor. This embodiment is advantageous in that there is no need for complicated transmission components which connect the turbine to the compressor. A conventional turbocharger may thus be used. On the other hand, it is conceivable that a gear is used to adapt the gearing ratio between the turbine and the compressor. For instance, the turbine may rotate at a higher speed than the compressor or vice versa. Of course, a gear with e.g. two co-operating cogwheels could also be used for transmission if the rotational axis of the turbine differs from that of the compressor.

The invention further provides a gas recirculation arrangement for a blast furnace plant with a blast furnace and a charging device for the blast furnace. The gas recirculation arrangement comprises at least one nozzle for introducing a clean gas into said charging device, a cleaning device, which is connectable for receiving gas from the blast furnace and arranged for removing dust from the gas. The arrangement further comprises least one compressor arranged for receiving gas from the cleaning device, compressing the gas and feeding the gas to the at least one nozzle and at least one turbine connectable for receiving and being driven by gas from the blast furnace, the at least one turbine being mechanically coupled to drive the at least one compressor. All these elements have been explained above with reference to the inventive blast furnace plant.

Preferred embodiments of the inventive gas recirculation arrangement correspond to those of the blast furnace plant.

The invention also provides a method for operating a blast furnace plant with a blast furnace and a charging device for the blast furnace. The inventive method comprises a cleaning device receiving gas from the blast furnace and removing dust from the gas, at least one compressor receiving gas from the cleaning device, compressing the gas and feeding the gas to at least one nozzle, the at least one nozzle introducing the clean gas into said charging device, and the at least one turbine receiving and being driven by gas from the blast furnace, the at least turbine being mechanically coupled to and driving the at least one compressor.

Preferred embodiments of the inventive method correspond to those of the blast furnace plant.

### BRIEF DESCRIPTION OF THE DRAWINGS

Preferred embodiments of the invention will now be described, by way of example, with reference to the accompanying drawings, in which:

FIG. 1 is a schematic representation of a first embodiment of a blast furnace plant according to the invention;

FIG. 2 is a schematic representation of a second embodiment of a blast furnace plant according to the invention;

FIG. 3 is a schematic representation of a third embodiment of a blast furnace plant according to the invention; and

FIG. 4 is a schematic representation of a fourth embodiment of a blast furnace plant according to the invention.

### DESCRIPTION OF PREFERRED EMBODIMENTS

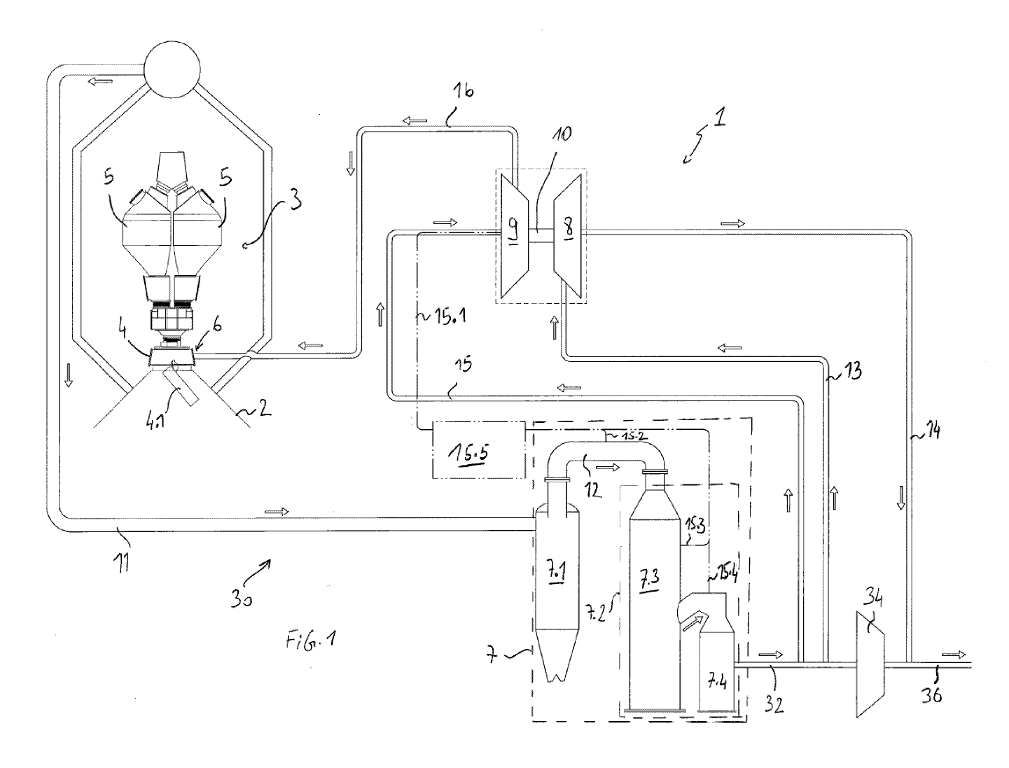

FIG. 1 shows a schematic representation of an inventive blast furnace plant 1. A charging installation 3 is placed on top of a blast furnace 2. In an upper part of the charging installation 3, raw materials are placed in material hoppers 5. From here, they are charged to the blast furnace by a rotational chute 4.1, which is suspended on a lower side of a main casing 4. The main casing 4 is formed by a stationary housing and a suspension rotor, as is known in the art (not shown in detail). To provide for a rotatability of the rotor with respect to the housing, there is a gap between the two elements, which is minor, but could be an entry path for gas and particles into the main casing 4. The chute 4.1 is pivotally suspended on the rotor so that it can be tilted around a horizontal axis. The rotor further allows rotating the chute 4.1 around the furnace axis.

To prevent dust-laden top gas from the blast furnace 2 from entering the main casing 4, an over-pressure cleaned gas is injected into the gear housing by at least one nozzle 6. Hereby the furnace gas is at least largely kept out of the main casing. The details of this process can be different. E.g. a plurality of nozzles 6 can create a curtain of clean gas which blocks a gap between two moving parts of the housing and/or the gas is just introduced into the casing 4 by one or more nozzles to create an overpressure therein.

The clean gas is obtained by means of a gas recirculation arrangement 30, which will now be described. High-temperature top gas is extracted from the blast furnace through a first pipe 11. This top gas is highly dust-laden and therefore is fed into a cleaning device 7, which performs a two-stage cleaning. The first pipe 11 is connected to a dust catcher 7.1 (or alternatively a cyclone), which in turn is connected by a second pipe 12 to a wet separator 7.2, which comprises a scrubber 7.3 and a demister 7.4. After the two cleaning steps, the gas has a residual dust content, which may e.g. be of less than 20 mg/m³. It may be noticed that cleaning of BF top gas is conventional in the art and the cleaning device 7 may be designed according to conventional practice.

In the following, the design of the gas recirculation arrangement will depend on the presence, or not, of a TRT (top gas recovery turbine) downstream of the cleaning device 7. As it is known in the art, the TRT turbine is generally driven by the cleaned top gas in order to drive itself an electric generator, while the expanded top gas is returned to the plant network and may be burned. Referring to FIG. 1, clean gas exits cleaning device 7 in a clean gas piping 32 connected to a TRT turbine indicated 34.

It shall be appreciated that a part of the cleaned top gas is fed from piping 32 through a third pipe 13 into a turbine 8, which is driven by the gas pressure. The expanded gas exits the turbine 8 through a fourth pipe 14, by which it is returned to the gas network 36 downstream of the TRT 34. Since the gas arriving at the network 36 still has a high content of combustible components, its energy content may be used to create heat by burning.

The turbine 8 is mechanically coupled to a compressor 9 by a transmission unit 10. The transmission unit 10 may simply be a common shaft which connects the compressor 9 to the turbine 8; accordingly a conventional turbocharger may be used. However, the transmission unit 10 may be more complex, e.g. it may comprise a gear for creating different rotation speeds for the turbine 8 and the compressor 9 etc.

The compressor 9 is fed with clean gas by a fifth pipe 15, which originates from clean gas piping 32. While the use of clean gas in the compressor is preferred for maintenance reasons, the use of top gas at a lower purity/cleanliness level is also possible, as will be explained further below. The gas is compressed and exits the compressor 9 via a sixth pipe 16, which ends at the nozzle 6. By way of this configuration, the energy required for driving the compressor 9 is exclusively obtained from the pressure of the gas fed the turbine 8, which pressure results from the energy of the top gas in the blast furnace 2. Therefore, the gas recirculation arrangement 30 works without external energy or external gas supply.

It remains to be noted that in a BF plant with TRT, the top gas pressure is mainly regulated via the TRT device. By picking up the top gas further upstream in the cleaning device, one can benefit from top gas at a higher pressure, however only partially cleaned. For example, mixed-line 15.1 indicates alternative piping possibilities for feeding top gas (partially cleaned) to compressor 9. The piping 15.1 leading to compressor 9 can be connected at its other end either to the outlet 15.2 of the first cleaning stage 7.1 or to the demister 7.3 or its outlet indicated 15.3 and 15.4. Also in some embodiments, the third piping 13 leading to turbine 8 could be connected further upstream in the cleaning device 7, e.g. after the first cleaning stage 7.1 or after the demister 7.3. In such cases using partially/semi cleaned top gas, a small cleaning unit may be arranged in the piping to the turbine or compressor, as e.g. indicated 15.5 in FIG. 1.

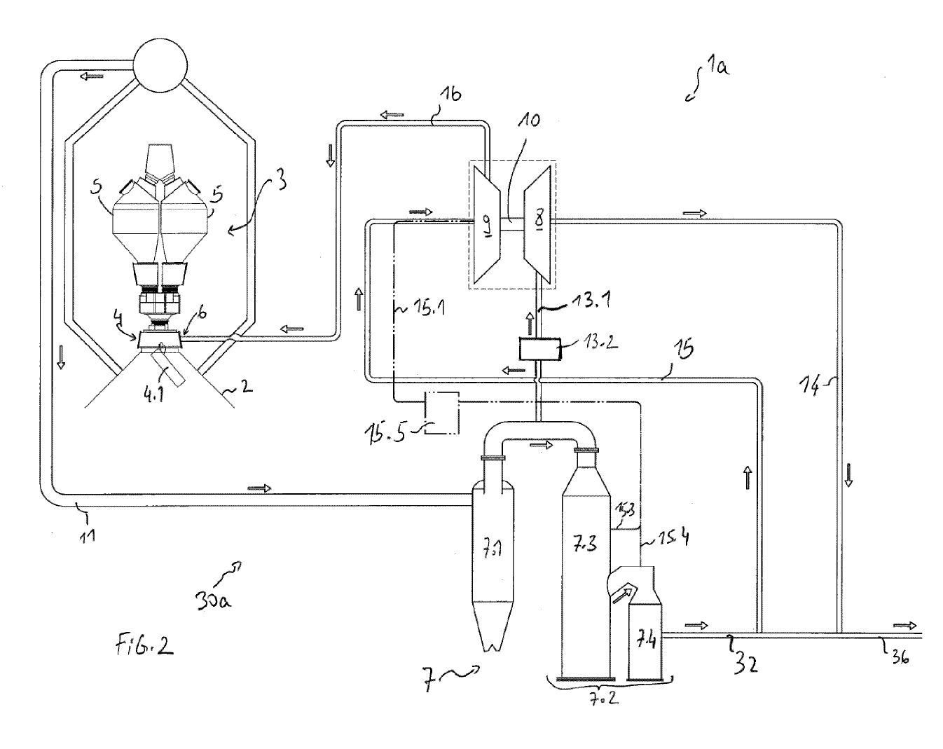

FIG. 2 shows a second embodiment of a blast furnace plant 1a with an alternative gas recirculation arrangement 30a. The components are largely identical to the embodiment shown in FIG. 1 and will insofar not be described again. In this embodiment, there is no TRT causing a pressure drop in the clean gas piping 32. The turbine 8 is therefore driven by semi-cleaned gas carried through a pipe 13.1 branching off from the connection pipe between the first 7.1 and second 7.2 cleaning stages. Reference 13.2 indicates an optional small gas cleaning unit.

Here again the mixed line 15.1 illustrates alternative piping options for feeding partially cleaned top gas to the compressor, which can be picked up at the desmister 7.3 or its outlet, as indicated 15.3 or 15.4. Reference sign 15.5 indicates an optional small cleaning unit.

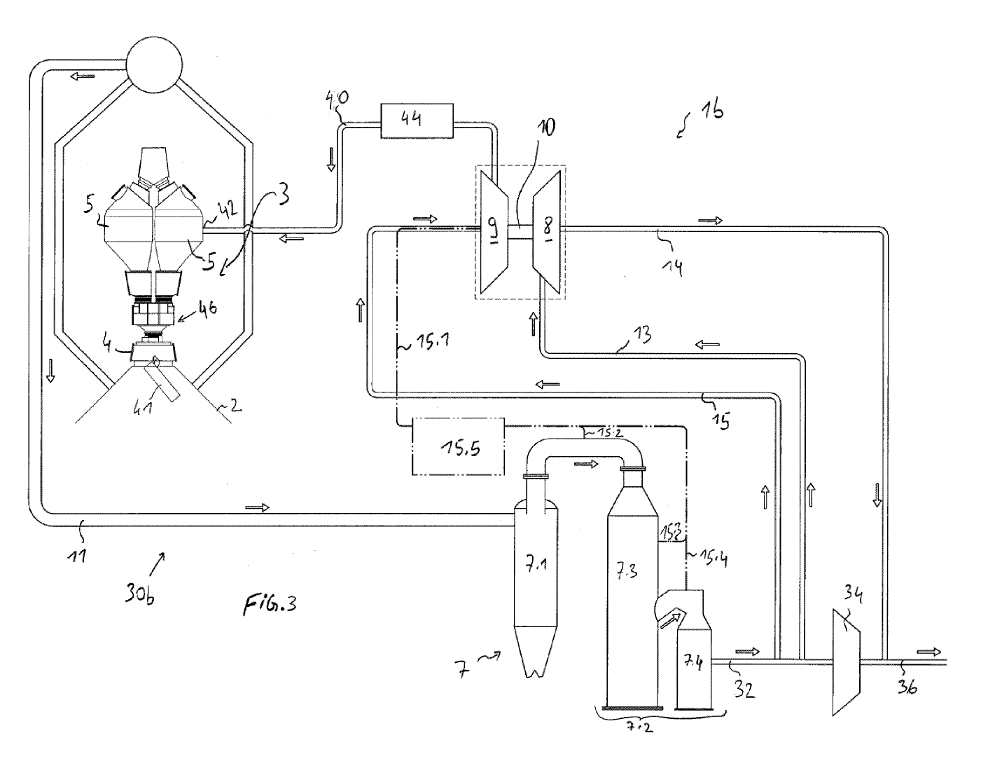

FIG. 3 shows a third embodiment of a blast furnace plant 1b, which is also largely similar to the embodiment shown in FIG. 1. It comprises a gas recirculation arrangement 30b that differs from the one shown in FIG. 1 in that a tenth pipe 40 originates from the compressor 9, which pipe 40 ends in at least one nozzle 42 for injecting clean gas into one or more material hoppers 5. This allows for pressure equalization in the hoppers, which would otherwise be performed by injecting nitrogen gas. It is understood that it would be possible to have the tenth pipe 40 originate from the sixth pipe 16 of FIG. 1 and to inject clean gas into the hopper 5 and into the main casing 4 at the same time.

It may be noticed that in this embodiment, the compressed clean gas is preferably stored in a buffer hopper 44. If desired, a piping may be connected from the buffer hopper to the valve actuation unit 46 controlling the material discharging and metering from the hoppers 5.

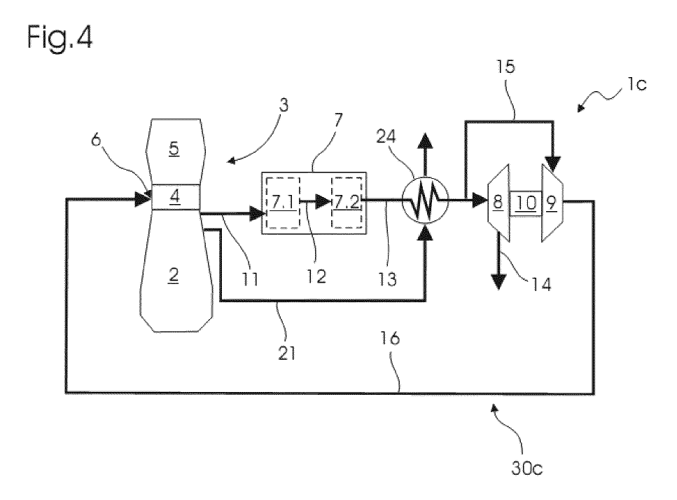

FIG. 4 shows a fourth embodiment of a blast furnace plant 1c with another slightly different gas recirculation arrangement 30c. The components, which are simplified in this representation, are largely identical to the embodiment shown in FIG. 1 and will insofar not be described again. The difference to the embodiment shown in FIG. 1 is that the third pipe 13 leads through a heat exchanger 24. An eleventh pipe 21 also leads to the heat exchanger 24. This pipe 21 originates from the blast furnace and guides high-temperature top gas to the heat exchanger 24. There, the high-temperature gas heats up the cleaned gas in the third pipe 13, thereby increasing its enthalpy and pressure. The efficiency of the turbine 8 is therefore significantly enhanced.

1. Blast furnace plant with a blast furnace and a charging device for the blast furnace, wherein the blast furnace plant further comprises:
at least one nozzle for introducing a clean gas into the charging device;
a cleaning device which is connected for receiving gas from the blast furnace and arranged for removing dust from the gas;
at least one compressor arranged for receiving gas from the cleaning device, compressing the gas and feeding the gas to the at least one nozzle; and
at least one turbine connected for receiving and being driven by gas from the blast furnace, the at least one turbine being mechanically coupled to drive the at least one compressor.

2. Blast furnace plant according to claim 1, wherein the charging device comprises a main casing with a stationary housing and a suspension rotor for a movable distribution chute, said suspension rotor being rotatably mounted with respect to the housing, wherein at least one of said nozzles is disposed for introducing the clean gas into the main casing.

3. Blast furnace plant according to claim 1, wherein the charging device comprises a hopper for raw materials to be fed into the blast furnace, wherein at least one of said nozzles is disposed for introducing gas into the hopper.

4. Blast furnace plant according to claim 1, wherein the cleaning device comprises a first cleaning stage and a second cleaning stage for sequentially cleaning the gas.

5. Blast furnace plant according to claim 4, wherein the turbine and/or compressor is/are connected to receive gas from the second cleaning stage.

6. Blast furnace plant according to claim 4, wherein the turbine and/or compressor is/are connected to receive gas from the first cleaning stage or another intermediate stage of the cleaning device.

7. Blast furnace plant according to claim 6, wherein a further cleaning unit is disposed between the first cleaning stage or intermediate stage and the turbine, respectively the compressor.

8. Blast furnace plant according to claim 5, wherein a heat exchanger is arranged between the second cleaning stage and the turbine, which heat exchanger is arranged to use heat from the blast furnace.

9. Blast furnace plant according to claim 1, wherein said at least one turbine and said at least one compressor are connected by a common shaft for concerted rotation.

10. Gas recirculation arrangement for a blast furnace plant with a blast furnace and a charging device for the blast furnace, which gas recirculation arrangement comprises:
at least one nozzle for introducing a clean gas into the charging device;
a cleaning device which is connectable for receiving gas from the blast furnace and arranged for removing dust from the gas;
at least one compressor arranged for receiving gas from the cleaning device, compressing the gas and feeding the gas to the at least one nozzle; and
at least one turbine connectable for receiving and being driven by gas from the blast furnace, the at least turbine being mechanically coupled to drive the at least one compressor.

11. Method for operating a blast furnace plant with a blast furnace and a charging device for the blast furnace, the method comprising:
a cleaning device receiving gas from the blast furnace and removing dust from the gas;
at least one compressor receiving gas from the cleaning device, compressing the gas and feeding the gas to at least one nozzle;
the at least one nozzle introducing the clean gas into the charging device; and
at least one turbine receiving and being driven by gas from the blast furnace, the at least turbine being mechanically coupled to and driving the at least one compressor.
